(19) United States
(12) Patent Application Publication
(10) Pub. No.: US 2013/0238327 A1
(43) Pub. Date: Sep. 12, 2013

(54) SPEECH RECOGNITION PROCESSING DEVICE AND SPEECH RECOGNITION PROCESSING METHOD

(71) Applicant: SEIKO EPSON CORPORATION, Tokyo (JP)

(72) Inventor: Tsutomu NONAKA, Hino-shi (JP)

(73) Assignee: SEIKO EPSON CORPORATION, Tokyo (JP)

(21) Appl. No.: 13/779,238

(22) Filed: Feb. 27, 2013

(30) Foreign Application Priority Data
Mar. 7, 2012 (JP) 2012-050117

(51) Int. Cl. G10L 21/0208

(52) U.S. Cl. CPC G10L 21/0208
USPC 704/233

(57) ABSTRACT

A speech recognition processing device includes a speech synthesis part, a speech output part, a speech input part, and a speech recognition part. A first synthesized sound and a second synthesized sound synthesized by the speech synthesis part are output from the speech output part. Noise information is obtained from a sound signal input from the speech input part between an output period of the first synthesized sound and an output period of the second synthesized sound, and the noise information is used for noise removal processing in the speech recognition part.

The entire disclosure of Japan Patent Application No. 2012-050117, filed Mar. 7, 2012 is expressly incorporated by reference herein.

### BACKGROUND

1. Technical Field

Several aspects of the present invention relates to speech recognition processing devices that recognize speech of the user.

2. Related Art

Voice processing devices that input user's voice, analyze the voice, and processes the voice according to the user are known. Such devices are used for telephone answering systems, guide systems to guide people through a building such as an art museum, and car navigation systems, for example. Voice of the user is captured into the voice processing device through a microphone, but in many cases, ambient sound around the user is also captured at the same time. Such sound works as noise when recognizing the user's voice, and becomes a factor to lower the voice recognition rate.

In view of the above, various devices have been implemented to perform predetermined processings to remove ambient sound. For example, JP-A-2004-20679 describes a noise suppression device that segments input voice signals at predetermined fixed intervals, discriminates voice sections from non-voice sections, and averages spectra in the non-voice sections, thereby estimating and continuously updating noise spectrum.

However, the noise suppression device described in JP-A-2004-20679 needs to constantly capture ambient sound, and estimates and continuously updates the spectrum of input signals in the non-voice sections. This requires the noise suppression device to be continuously operated during the speech recognition processing, which is considered to be a factor that prevents reduction of the power consumption. Furthermore, though input voice signals are segmented by predetermined fixed intervals so as to discriminate voice sections from non-voice sections, the timing of speech by the user may not necessarily be synchronized with the predetermined fixed intervals, such that sections that include some voice components and thus are not completely non-voice sections may be determined as non-voice sections. If such incidents occur frequently, noise spectra could possibly become unfavorable.

Moreover, the condition around the device may not always necessarily stay the same. Therefore, there are possibilities that noise in the non-voice sections where the user is not present may greatly differ from noise where the user is present. Constant estimation and update of noise spectra including noise spectra in the predetermined fixed intervals where the user is not present may present undesirable noise spectra in performing speech recognition.

### SUMMARY

In accordance with some aspects of the invention, at least a part of the problems described above will be solved, and the invention can be realized by the following embodiments or application examples.

### APPLICATION EXAMPLE 1

A speech recognition processing device in accordance with an application example 1 includes a speech synthesis part, a speech output part that outputs speech synthesized in the speech synthesis part, a speech input part, and a speech recognition part that renders speech recognition on sound input from the speech input part. A first sentence synthesized in the speech synthesis part contains a first word and a second word. The first word synthesized in the speech synthesis part defines a first synthesized sound, and the second word synthesized in the speech synthesis part defines a second synthesized sound. Based on sound input from the speech input part in a third period in which speech is not output from the speech output part, between a first period when the first synthesized sound is output and a second period when the second synthesized sound is output, correction information to be used for removing noise from a speech signal subject to speech recognition is generated.

According to this configuration, correction information to be used for noise removal is generated from a sound signal input in the third period where speech sound is not output between the first synthesized sound and the second synthesized sound synthesized in the speech synthesis part, and the correction information is used for removing noise from a sound signal that is subject to speech recognition. Therefore, it is not necessary to constantly perform signal generation processing for noise removal, such that the power consumption can be reduced, compared with the device that constantly performs noise removal.

Moreover, it is thought that, in the third period, which is an interval between outputs of synthesized sound, the possibility for the user pronouncing speech sound is low, and thus the third periods often become non-voice sections where the user's voice is not included. Therefore, comparing the noise spectrum calculated in the case of segmenting a signal by a predetermined fixed interval with the noise spectrum calculated in the third period, the noise spectrum calculated in the third period contains less voice spectrum components of the user. Thus, it can be judged that using the correction information for removing noise generated from the sound signal input in the third period is more effective in improving the voice recognition rate.

When the processing is performed interactively with the user, the user is present when the speech recognition processing device is outputting speech sound generated by the speech synthesis. Therefore, the correction information for noise removal generated based on a sound signal input in the third period does not include information of ambient sounds that may be present when the user is not present. Therefore, it can be judged that the speech recognition processing device in accordance with the present embodiment is effective in improving the speech recognition rate.

### APPLICATION EXAMPLE 2

In the speech recognition processing device in accordance with the application example described above, the second word may preferably be a word next to the first word.

According to such a configuration, as the second word is a word next to the first word, the third period can be defined as a period between the consecutive two words, and the third period can be readily set.

The speech output part receives a speech synthesized signal synthesized by the speech synthesis part and outputs the same as speech sound. Therefore, the timing at which the first synthesized sound and the second synthesized sound are output to the speech synthesis part can be specified in the speech synthesis part or the speech output part, and therefore the third period can be specified according to this timing. In this case, the third period can be set if two meanings, start and the stop, can be expressed, in the case of consecutive words. The control of such settings can be achieved by 1-bit expression when, for example, the control in the toggle form is assumed. Accordingly, the third period can be readily set as the control can be done with less information.

### APPLICATION EXAMPLE 3

In the speech recognition processing device in accordance with the application example described above, the correction information may preferably be generated based on sound input in a plurality of the third periods.

According to this configuration, the correction information is generated based on sound input in a plurality of the third periods, such that the correction information can be generated with the influence by sudden noise being mitigated.

The correction information based on sound input in a plurality of the third periods may be generated through averaging the results of correction information calculated in the respective third periods, or through storing sound inputs in a predetermined number of the third periods, and calculating correction information using the stored sound inputs. Either of the methods may be used based on judgment that takes into consideration the state of use of the speech recognition processing device, its surrounding environment, etc., or after conducting the actual use test, one of the methods with a desirable result may be used.

Moreover, in the speech recognition processing device in the application example described above, in addition to the above, the correction information may preferably be generated in consideration of an analysis result of sound input in a predetermined period before the first sentence is output from the speech output part.

According to this configuration, by further adding an analysis result of sound input in a predetermined period before the first sentence is output from the speech output part, the period for acquiring information for generating the correction information can be increased.

### APPLICATION EXAMPLE 4

A speech recognition processing method for a speech recognition processing device, in accordance with an application example 4, the speech recognition processing device including a speech synthesis part, a speech output part and a speech input part. When a first sentence synthesized in the speech synthesis part contains a first word and a second word, the first word synthesized in the speech synthesis part defining a first synthesized sound, and the second word synthesized in the speech synthesis part defining a second synthesized sound, the method includes generating correction information based on sound input from the speech input part in a third period when speech is not output from the speech output part, between a first period when the first synthesized sound is output and a second period when the second synthesized sound is output, and using the correction information for removing noise from a speech signal to be used for speech recognition.

According to the method described above, when a first sentence synthesized in the speech synthesis part contains a first word and a second word, and the first word synthesized in the speech synthesis part defines a first synthesized sound, and the second word synthesized in the speech synthesis part defines a second synthesized sound, correction information is generated based on sound input from the speech input part in a third period when speech is not output from the speech output part, between a first period when the first synthesized sound is output and a second period when the second synthesized sound is output, and the correction information is used for removing noise from a speech signal that is subject to speech recognition. Therefore, it is not necessary to constantly perform signal generation processing for noise removal, such that the power consumption can be reduced, compared with the device that constantly performs noise removal.

Moreover, it is thought that, in the third period, which is an interval between outputs of synthesized sound, the possibility for the user pronouncing speech sound is low, and thus the third periods often become non-voice sections where the user's voice is not included. Therefore, comparing the noise spectrum calculated in the case of segmenting a signal by a predetermined fixed interval with the noise spectrum calculated in the third period, the noise spectrum calculated in the third period contains less voice spectrum components of the user. Thus, it can be judged that using the correction information for removing noise generated from a sound signal input in the third period is more effective in improving the voice recognition rate.

Furthermore, for example, when the processing is performed interactively with the user, the user is present when the speech recognition processing device is outputting speech sound generated by the speech synthesis. Therefore, the correction information for noise removal generated based on a sound signal input in the third period does not include information of ambient sound generated when the user is not present. Therefore, it can be judged that the processing method in accordance with the present embodiment is even more effective in improving the voice recognition rate.

### BRIEF DESCRIPTION OF THE DRAWINGS

FIG. 1 is a schematic block diagram of a speech recognition processing device.

FIG. 2 is a schematic diagram of the state of the speech recognition processing device in use.

FIGS. 3A and 3B are illustrations of a sentence and speech waveform.

FIG. 4 is an illustration of speech waveform including noise.

FIG. 5 is an illustration of a first sound spectrum.

FIG. 6 is an illustration of sound spectra of speech sound including noise.

FIG. 7 is an illustration of sound spectra of speech sound.

### DESCRIPTION OF PREFERRED EMBODIMENTS

The invention will be described with reference to the accompanying drawings. Note that the drawings to be used for the description are supplementary drawings only sufficient to describe the invention. Therefore, the drawings may not depict every constituting elements of the device, and the shapes of signals and waveforms illustrated therein may be different from those of the actual signals and waveforms.

### First Embodiment

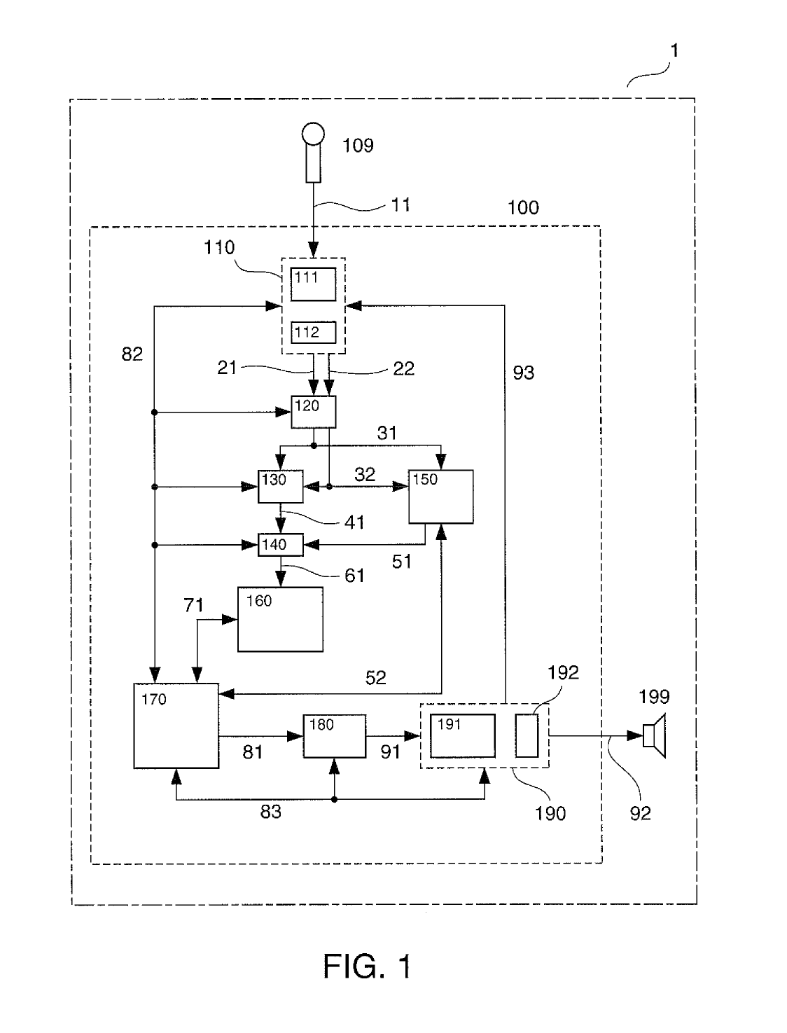

FIG. 1 shows a speech recognition processing device 1 to which the invention is applied. The speech recognition processing device 1 includes a processing part 100, a microphone 109, and a speaker 199. Moreover, the processing part 100 includes a speech input part 110, a frequency analysis part 120, a speech signal control part 130, a noise removal part 140, a noise removal signal generation part 150, a speech recognition part 160, a control part 170, a speech synthesis part 180, and a speech output part 190. Moreover, although not shown in the figure, a monitor, a keyboard, a mouse, etc., which are used to present information to the user of the speech recognition processing device 1 and to operate the speech recognition processing device 1, may also be included in the speech recognition processing device 1 or the processing part 100.

The control part 170 is a unit that controls the processing part 100. A variety of control signals, buses, etc. necessary for the control are connected with the control part 170. A control signal 82 collectively shows plural control signal and data signal lines for the speech input part 110, the frequency analysis part 120, the speech signal control part 130, and the noise removal part 140. A control signal 83 collectively shows plural control signal and data signal lines for the speech synthesis part 180 and the speech output part 190. The control part 170 and the speech recognition part 160 are connected through a first bus signal 71. The control part 170 and the noise removal signal generation part 150 are connected through a second bus signal 52. Moreover, various interruption signals, etc. for the control part 170 exist in the processing part 100, though they are not shown in the figure.

The control part 170 may be composed of, for example, a MCU (Micro Control Unit) and a memory device. Applications, etc. to be executed in the speech recognition processing device 1 may be executed by the control part 170.

The speech input part 110 also includes an analog-to-digital converter 111 (hereinafter referred to as an AD converter 111) and a buffer 112. An analog sound signal 11 output from the microphone 109, is converted into a digital signal by the AD converter 111, then retained in the buffer 112 having a predetermined capacity, and output as a digital sound signal 21 to the frequency analysis part 120 at a predetermined timing.

In the speech input part 110, operation modes are set and state management is performed by the control part 170 through the control signal 82. A timing signal 93 output from the speech output part 190 is a signal to identify a noise detection period. Here, the noise detection period is a period in which the speech input part 110 samples a sound signal for generating information for noise removal, and it is a period when speech sound is not output, such as, an interval between phrases or words appearing while the speech recognition processing device 1 is giving some information in speech sound such as a guiding instruction to the user. The speech input part 110 identifies noise detection periods from other periods according to the timing signal 93, and stores the outputs from the AD converter 111 at respective periods in the buffer 112 in an identifiable manner. The control signal 22 is a signal to identify as to whether a signal output as the digital sound signal 21 is the one in the noise detection period. The digital sound signal 21, if provided when the control signal 22 is active, may be set as belonging to a noise detection period.

The frequency analysis part 120 resolves the digital sound signal 21 to frequency components, and outputs them as a spectrum signal 31. The spectrum signal 31 is output to the speech signal control part 130 and the noise removal signal generation part 150. Here, the frequency component (signal) that is obtained by resolving the digital sound signal 21 will be referred to as a sound spectrum (a sound spectrum signal) and, in particular, the sound spectrum (the sound spectrum signal) in the noise detection period will be referred to as a first sound spectrum (a first sound spectrum signal). The frequency component (signal) obtained by resolving the digital sound signal 21 that is transmitted when the control signal 22 is active is the first sound spectrum (the first sound spectrum signal). The control signal 32 is in the active state, when the spectrum signal 31 that is output from the frequency analysis part 120 is the first sound spectrum signal.

The speech signal control part 130 selectively outputs the sound spectrum (the sound spectrum signal) to be used for speech recognition to the noise removal part 140. The sound spectrum signal may be selected depending on whether it is the first sound spectrum signal. Sound spectrum signals other than the first sound spectrum signal are output to the noise removal part 140. Moreover, it is also possible that the speech signal control part 130 outputs all the sound spectrum signals to the noise removal part 140 without selection. The aforementioned operations are set by the control signal 82 output from the control part 170.

The noise removal part 140 performs noise removal with respect to the sound spectrum (the sound spectrum signal), using a noise spectrum generated by the noise removal signal generation part 150. The noise spectrum is output from the noise removal signal generation part 150 as a noise spectrum signal 51. More specifically, the noise removal is performed by subtracting the noise spectrum from the sound spectrum. The sound spectrum, to which the noise removal has performed, is output to the speech recognition part 160 as a speech spectrum signal 61 for speech recognition processing.

The noise removal signal generation part 150 generates a noise spectrum to be output as a noise spectrum signal 51 from the first sound spectrum (the first sound spectrum signal). The noise removal signal generation part 150 is controlled by the control part 170 through the second bus signal 52. The noise spectrum signal 51 may be calculated, for example, as an average value in a predetermined period. The predetermined period may be set by the control part 170 through the second bus signal 52. The predetermined period may be closed within one processing of an application for the user, or may be succeeded while the application is repeatedly executed multiple times.

The speech recognition part 160 is a unit where the speech recognition processing is rendered on the sound spectrum sent as the speech spectrum signal 61. Because the invention is applicable and usable regardless of any speech recognition methods, a concrete method of speech recognition is not especially described in the embodiment.

The speech synthesis part 180 performs speech synthesis with respect to data for speech synthesis 81 output from the control part 170. Because the speech synthesis method is not directly relevant to the invention, a concrete speech synthesis method is not described, but the data for speech synthesis 81 may be composed of character codes, for example. Speech data of which speech is synthesized is output to the speech output part 190 as speech synthesis data 91 with timing codes that direct the timing of outputting speech sounds. The timing code is a code indicative of the period in which speech sound is not uttered, which may specify a unit for continuously generating speech sounds. The unit may be, for example, a phrase unit, a word unit or the like.

The speech output part 190 converts the speech synthesis data 91 into an analog speech signal 92 and outputs the same to the speaker 199. Speech output data is adjusted at a predetermined timing by the output control part 191, and output to a digital-to-analog converter 192 (hereafter referred to as a DA converter 192) to be converted into an analog speech signal 92. The predetermined timing is specified by the timing codes included in the speech synthesis data 91. Also, the timing signal 93 is a signal generated by the output control part 191 based on the timing code included in the speech synthesis data 91.

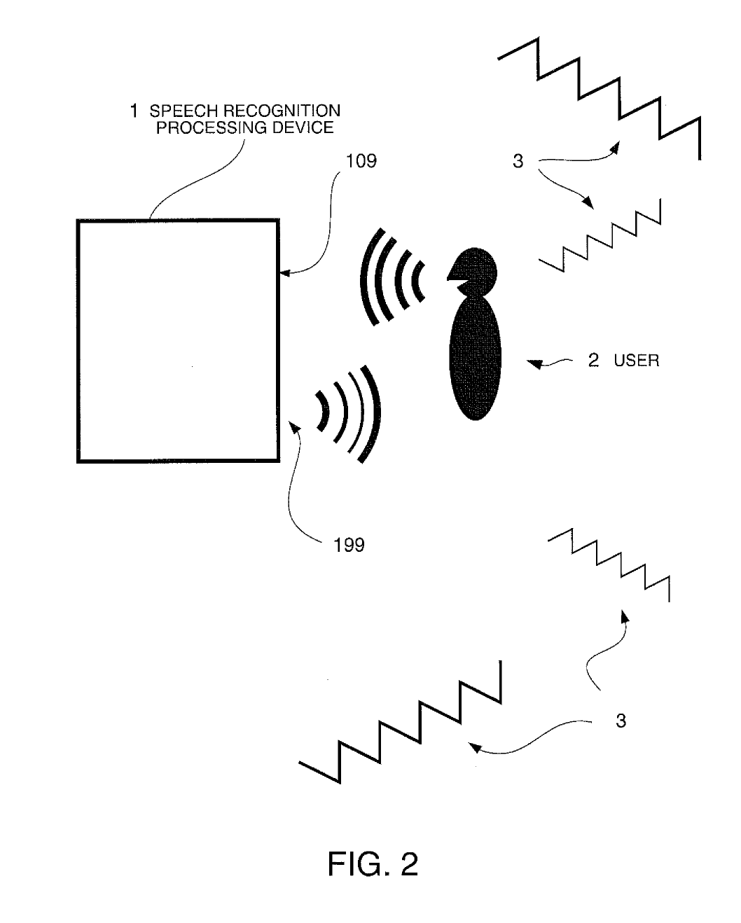

FIG. 2 is an illustration of the state in which the speech recognition processing device 1 is used. Speech sound to the user 2 is output from the speaker 199, and speech sound of the user 2 is input through the microphone 109. Noise 3 exists around the user 2. The noise 3 is input through the microphone 109 together with the speech sound of the user 2, and will be taken into the speech recognition processing device 1.

### EMBODIMENT EXAMPLE 1

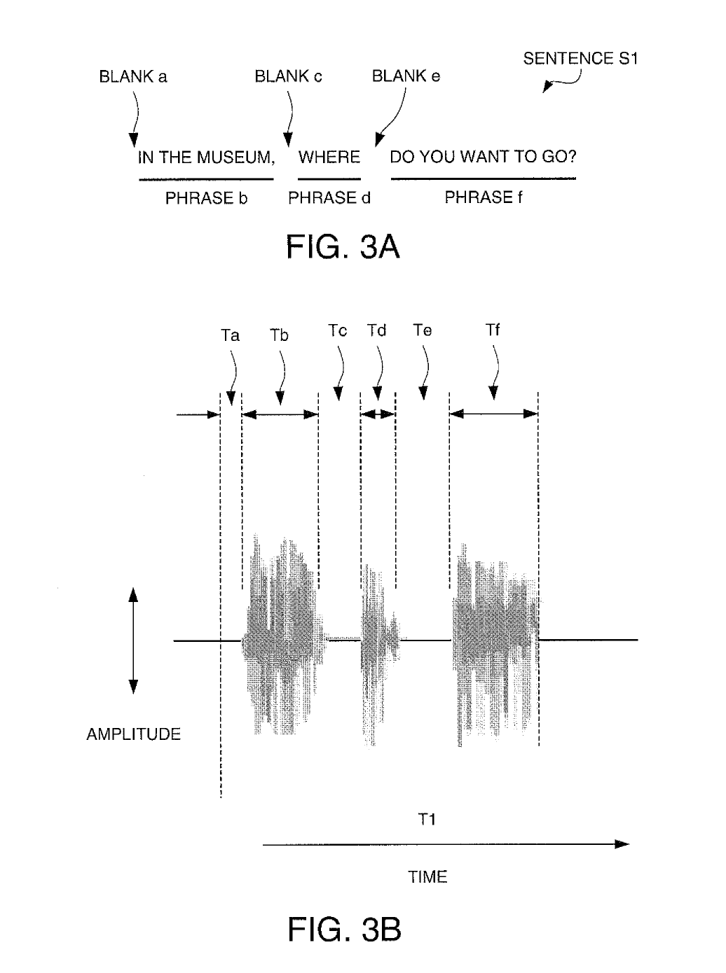

The embodiment example 1 is an exemplary case where the speech recognition processing device 1 is used as a gallery guide device in an art museum. The task of the speech recognition processing device 1 in the embodiment example 1 is to transmit guide information of the art museum to the user 2, and to answer questions given by the user 2. An example of a sentence used by the speech recognition processing device 1 when it guides the user 2 is shown in FIG. 3A as a sentence S1. FIG. 3B shows a waveform of the sentence S1 as it is output from the speaker 199 as speech sound. The horizontal axis shows the passage of time, and the vertical axis shows the magnitude of the amplitude.

The sentence S1 is used, being divided into three phrases of “In the museum,” (phrase b), “where” (phrase d), and “do you want to go?” (phrase f). Each of the phrases is output to the user 2 as a series of connected sounds. The period between one phrase and the next phrase is a period in which speech sound is not output from the speech recognition processing device 1. The period in which speech sound is not output will be referred to as a third period. The third period between the phrase b and the phrase d is a blank c, and the third period between the phrase d and the phrase f is a blank e. The period during which the sentence S1 is output is managed by the control part 170, and this period is T1 in FIG. 3B (hereafter referred to as a period T1). Note that the third period prior before the phrase b is output, a blank a exists in the period T1.

The control part 170 outputs data for speech synthesis 81 to the speech synthesis part 180 for outputting the sentence Si. As described above, the data for speech synthesis 81 includes data for synthesis to be used for speech synthesis, and timing codes to control the time between predetermined phrases, respectively. The data for synthesis and the timing codes are output from the control part 170 to the speech synthesis part 180 in the order of processings. In the present embodiment example, the data for speech synthesis 81 is composed of a start code, a timing code a, data for synthesis of the phrase b, a timing code c, data for synthesis of the phrase d, a timing code e, data for synthesis of the phrase f, and an end code. Here, the timing code a specifies the blank a, the timing code c specifies the blank c, and the timing code e specifies the blank e.

The speech synthesis part 180 synthesizes digital speech data for output from the data for synthesis of each phrase. The speech synthesis part 180 outputs the digital speech data and the timing codes to the speech output part 190 as the speech synthesis data 91 in the order by which they are output from the speaker 199. The speech synthesis data 91 is received by the output control part 191 in the speech output part 190. In the present embodiment example, the speech synthesis data 91 is composed of the start code, the timing code a, digital speech data of the phrase b, the timing code c, digital speech data of the phrase d, the timing code e, digital speech data of the phrase f, and the end code.

The output control part 191 executes the processing, assuming that the period T1 is defined by the start code and the end code in the speech synthesis data 91. The output control part 191, when the start code in the speech synthesis data 91 is identified, recognizes that the new period T1 started and begins the processing. An amplifier to drive the signal at the speaker 199 may exist in the speech synthesis part 180, though not shown in the figure. The output control part 191 can identify the period T1, such that the power supply for operating the amplifier can be controlled. The power supply for operating the amplifier other than the period T1 can be turned off, such that the power consumption by the speech recognition processing device 1 can be reduced. Note that the control part 170 may also be able to control the start of operation of the speech input part 110, the frequency analysis part 120, the speech signal control part 130, the noise removal part 140, the noise removal signal generation part 150, and the speech recognition part 160, through the control signal 82 based on the timing at which the start code is output to the speech synthesis part 180. The power consumption can be further reduced by controlling the power supply such that the operation is started according to the beginning of the period T1, though it depends on the application to be executed.

The output control part 191 outputs the digital speech data to the DA converter 192 according to the timing provided for by the timing codes. The digital speech data is converted into an analog signal by the DA converter 192, transmitted to the speaker 199 as an analog speech signal 92, and output as a speech from the speaker 199.

When the start code is recognized, the output control part 191 begins a predetermined control necessary for speech output.

Next, the output control part 191 sets the timing signal 93 to an active state along with the beginning of a period defined by the timing code a.

The output control part 191 releases the active state of the timing signal 93 after a period specified by the timing code a has elapsed, and outputs the digital speech data of the phrase b to the DA converter 192. The digital speech data of the phrase b is converted into an analog signal by the DA converter 192, transmitted to the speaker 199 as an analog speech signal 92, and output as speech sound. When digital-to-analog conversion (hereafter referred to as DA conversion) of the digital speech data of the phrase b ends, the DA converter 192 notifies the output control part 191 of the end of the conversion.

When the notification of the end of the DA conversion is received from the DA converter 192, the output control part 191 performs the control concerning the timing code c. After setting the timing signal 93 in an active state for the period specified by the timing code c, the output control part 191 outputs digital speech data of the phrase d to the DA converter 192. When DA conversion of the digital speech data of the phrase d ends, the DA converter 192 notifies the output control part 191 of the end of the conversion.

When the notification of the end of the DA conversion is received from the DA converter 192, the output control part 191 performs the control concerning the timing code e. After setting the timing signal 93 in an active state for the period specified by the timing code e, the output control part 191 outputs digital speech data of the phrase f to the DA converter 192. When DA conversion of the digital speech data of the phrase f ends, the DA converter 192 notifies the output control part 191 of the end of the conversion.

When the notification of the end of the DA conversion is received from the DA converter 192, the output control part 191 performs a processing specified by the end code which is the processing code to be executed next. The processing specified by the end code also includes a processing that notifies the control part 170 of the end of processing of the speech synthesis data 81 corresponding to the sentence S1. By the notification of the end of the processing from the output control part 191, the control part 170 can recognize the end of the period T1, in other words, the end of speech output of the sentence S1. Note that, after a predetermined period that is deemed to be a sufficient time period for answering a question by the user 2 after the period T1 ends, it is also possible that the control part 170 may control to stop the operation of the speech input part 110, the frequency analysis part 120, the speech signal control part 130, the noise removal part 140, the noise removal signal generation part 150, and the speech recognition part 160 through the control signal 82.

As described above, the timing code included in the speech synthesis data 81 output from the control part 170 is transmitted to the output control part 191, and the state of the timing signal 93 is controlled by the output control part 191. FIG. 3B shows the waveform of the sentence S1 as it is output from the speaker 199. In the figure, Tb shows the waveform of the phrase b, Td shows the waveform of the phrase d, and Tf shows the waveform of the phrase f. Ta, Tc, and Te are all the third periods, which are periods when the timing signal 93 is in the active state.

In the speech input part 110, an output of the AD converter 111 when the timing signal 93 is in the active state is appended with an identification flag indicating that the output belongs to the third period, and stored in the buffer 112. The data with the identification flag added and stored in the buffer 112 is output to the frequency analysis part 120 as a digital sound signal 21 when the control signal 22 is active.

The frequency analysis part 120 performs a processing to the digital sound signal 21 when the control signal 22 is active, and a processing to the digital sound signal 21 when the control signal 22 is not active independently from each other. Note that the digital sound signal 21 is segmented by a predetermined fixed time interval that is decided in advance, and is subject to the frequency analysis. Accordingly, it is possible that the sections of the digital sound signal when the control signal 22 is active and not active may not correspond to the predetermined time intervals. The processing in this case may be accomplished by interpolating a portion that does not come up at the predetermined time interval with data indicative of zero amplitude. Moreover, when the digital sound signal 21, which does not come up at the predetermined time interval, was given when the control signal 22 was active, such digital sound signal 21 may be excluded from being a subject of the frequency analysis.

The control signal 32 becomes an active state when the spectrum signal 31 output from the frequency analysis part 120 is the first sound spectrum signal. The noise removal signal generation part 150 can take in the first sound spectrum signal by taking the spectrum signal 31 when the control signal 32 is active.

Moreover, the control signal 32 is also output to the speech signal control part 130. The speech signal control part 130 can take in only the spectrum signal 31 when the control signal 32 is not active, so as not to take in the first sound spectrum signal. The speech signal control part 130 may take in all the spectrum signals 31 by associating the spectrum signals 31 and the control signal 32 in both of the states and storing them. How the spectrum signals 31 are taken in is directed by the control part 170 through the control signal 82. The sound spectrum signals that are not at least the first sound spectrums among the sound spectrums taken in the speech signal control part 130 are output to the noise removal part 140 as selected spectrum signals 41.

As described above, the spectrums are components that are segmented by a predetermined time interval decided beforehand and are subject to analysis. However, the predetermined time interval decided in advance is considerably short, compared even with a single third period, and a plurality of the predetermined intervals decided in advance exist in the single third period alone. Although noise spectrum signals 51 are generated in the noise removal signal generation part 150, how they should be generated is instructed by the control part 170 through the second bus signal 52. The noise spectrum may be generated as follows. For example, a predetermined number of the first sound spectra may be stored, and an average of the predetermined number of the first sound spectra may be calculated to provide an average spectrum, or an average between a noise spectrum used immediately before and a new first sound spectrum may be calculated. Also, the latest first sound spectrum may always be used. Alternatively, the control part 170 may transmit a base spectrum through the second bus signal 52, and an average spectrum between the base spectrum and the first sound spectrum may be used as a nose spectrum. After removing noise from the spectrum using the noise spectrum transmitted as the noise spectrum signal 51, the noise removal part 140 outputs the spectrum to the speech recognition part 160 as a speech spectrum signal 61.

It is the sound spectra other than the first sound spectra, that the noise removal part 140 removes noise and at least outputs to the speech recognition part 160 as the voice spectrum signal 61. However, the first sound spectrum may be transmitted as the selected spectrum signal 41, and the noise removal part 140 may perform noise removal on the first sound spectrum signal. As a result, for example, if spectra more than a predetermined amount remains in the spectra that are the result of noise removal from the first sound spectra, the noise removal part 140 may demand an interruption to the control part 170 and can notify the possibility that the speech recognition rate may worsen.

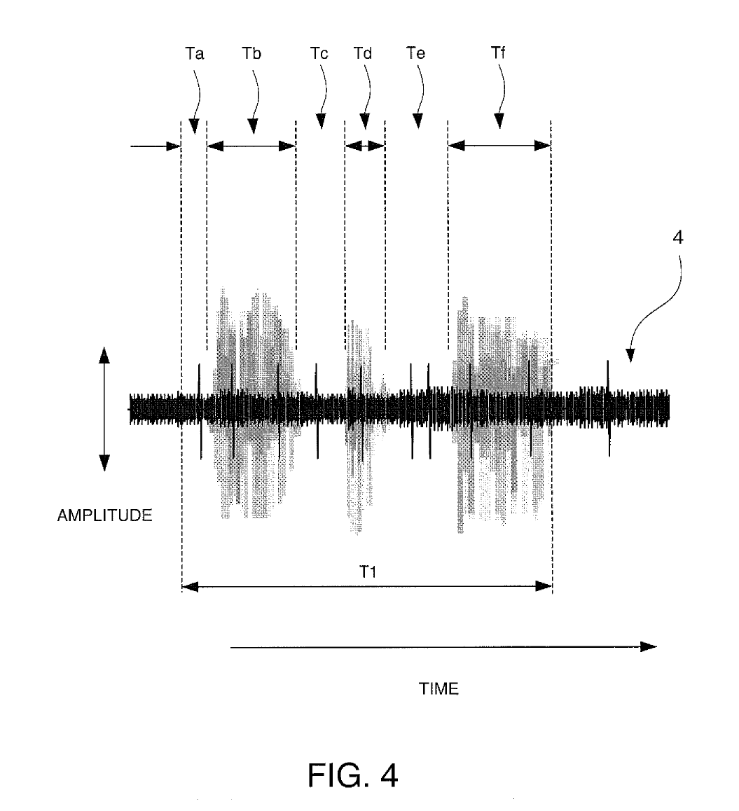

FIG. 4 shows an example of a waveform in which a noise waveform 4 is superposed on the speech waveform of the sentence S1 shown in FIG. 3B. A waveform input from the microphone 109 while actually operating the speech recognition processing device 1 may become the one shown in FIG. 4.

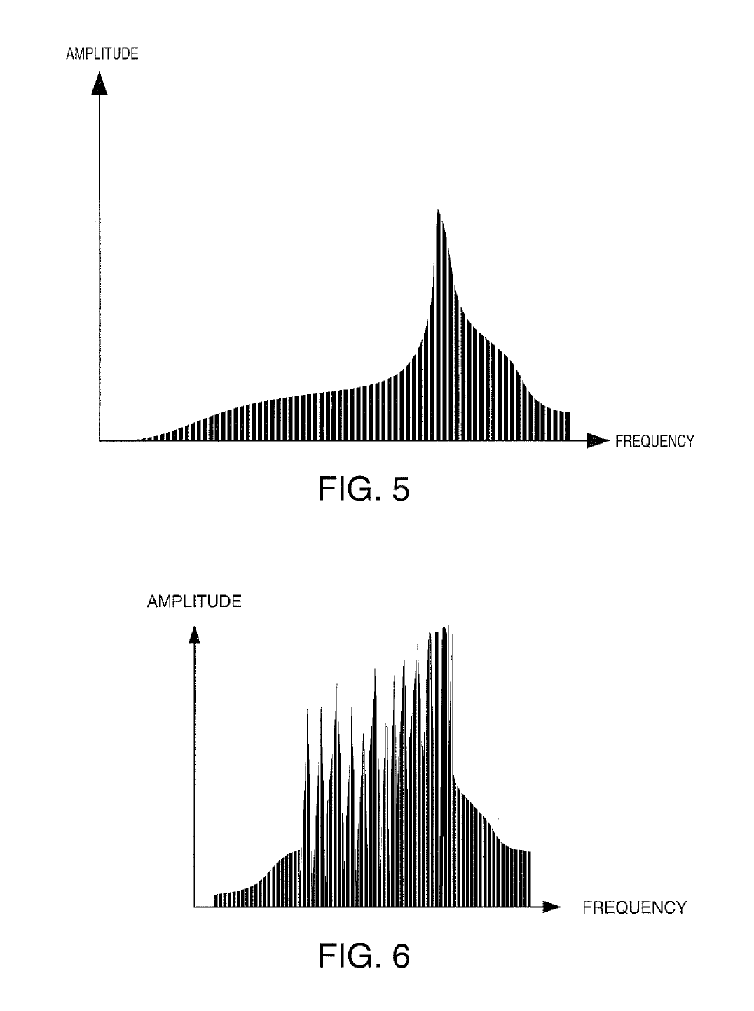

FIG. 5 shows an example of a noise spectrum that is generated in the noise removal signal generation part 150. It is a noise spectrum generated based on the sound input in the third period, and it is output to the noise removal part 140 as the noise spectrum signal 51 as described above.

FIG. 6 shows an example of a sound spectrum that is output as the selected spectrum signal 41. The sound spectrum that is output as the selected spectrum signal 41 may be a mixture of the speech spectrum of the user 2 and the spectrum of noise 3 present when the user 2 utters speech.

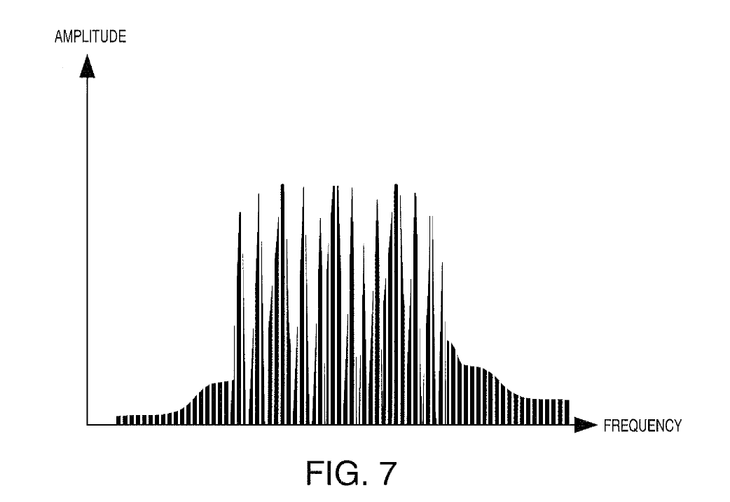

FIG. 7 shows an example of a spectrum that is output as the speech spectrum signal 61. It is the one that the noise spectrum input as the noise spectrum signal 51 is subtracted from the sound spectrum input as the selection spectrum signal 41. The spectrum output as the speech spectrum signal 61 will be subject to the speech recognition processing in the speech recognition part 160.

By the application of the invention, it becomes easier to set the period of identifying noise, the circuit device concerning the noise removal can be simplified, and the period of operating the device can be defined, such that the speech recognition processing device capable of reducing the power consumption can be composed.

The invention has been described above, but the invention can be executed without any limitation to the application examples and embodiments described above. The execution of the invention is widely applicable in the range that does not deviate from the subject matter of the invention.

What is claimed is:

1. A speech recognition processing device comprising:
a speech synthesis part;
a speech output part that outputs speech synthesized in the speech synthesis part;
a speech input part; and
a speech recognition part that renders speech recognition on sound input from the speech input part,
when a first sentence synthesized in the speech synthesis part contains a first word and a second word, the first word synthesized in the speech synthesis part defines a first synthesized sound, and the second word synthesized in the speech synthesis part defines a second synthesized sound,
correction information used for removing noise from a speech signal to be used for the speech recognition being generated based on sound input from the speech input part in a third period when speech is not output from the speech output part, between a first period when the first synthesized sound is output and a second period when the second synthesized sound is output.

2. The speech recognition processing device according to claim 1, wherein the second word is a word next to the first word.

3. The speech recognition processing device according to claim 1, wherein the correction information is generated based on sound input in a plurality of the third periods.

4. A speech recognition processing method for a speech recognition processing device, the speech recognition processing device including a speech synthesis part, a speech output part and a speech input part,
the method comprising: when a first sentence synthesized in the speech synthesis part contains a first word and a second word, the first word synthesized in the speech synthesis part defines a first synthesized sound, and the second word synthesized in the speech synthesis part defines a second synthesized sound,
generating correction information based on sound input from the speech input part in a third period when speech is not output from the speech output part, between a first period when the first synthesized sound is output and a second period when the second synthesized sound is output; and
using the correction information for removing noise from a speech signal subject to speech recognition.
